(19) United States
(12) Patent Application Publication
(10) Pub. No.: US 2008/0142766 A1
(43) Pub. Date: Jun. 19, 2008

(54) Power cord winding apparatus for use in vacuum cleaner

(75) Inventors: Min-Jo Choi, Gwangju-City (KR); Tae-Gwang Kim, Seo-Gu (KR)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Samsung Gwangju Electronics Co., Ltd.

(21) Appl. No.: 11/805,053

(22) Filed: May 22, 2007

(30) Foreign Application Priority Data
Dec. 13, 2006 (KR) 10-2006-127181

(51) Int. Cl. B25B 25/00

(52) U.S. Cl. 254/209

(57) ABSTRACT

A power cord winding apparatus for manually winding a power cord of a vacuum cleaner. The apparatus includes a loop body in the form of a pipe and having an opening formed on a side thereof, a door cover hinged to the opening of the loop body, three rollers rotatably disposed in the loop body to support a power cord passing through the inside of the loop body, a connecting part extended from an opposite side to the side of the loop body on which the opening is formed, and an arch part the form of an arch above the connecting part.

### CROSS-REFERENCE TO RELATED APPLICATIONS

This application claims the benefit under 35 U.S.C. 119(a) of Korean Patent Application No. 10-2006-0127181, filed Dec. 13, 2006, in the Korean Intellectual Property Office, the entire disclosure of which is incorporated herein by reference.

### BACKGROUND OF THE INVENTION

1. Field of the Invention

The present disclosure relates generally to a vacuum cleaner and, more particularly, to a power cord winding apparatus, which in a vacuum cleaner not having an automatic winding apparatus, allows a user to wind a power cord and thus to put the power cord in order without directly touching the power cord.

2. Description of the Related Art

In general, a vacuum cleaner has an elongated power cord to supply electric power to a motor for producing a suction force. Accordingly, most of the vacuum cleaners are provided with an automatic winding apparatus capable of automatically winding up the power cord to keep in a cleaner body. However, some vacuum cleaners having a very elongated power cord often wind and keep the power cord on the outside of the cleaner body without using the automatic winding apparatus.

Particularly, in an upright vacuum cleaner, since a required length of the power cord is long, the upright vacuum cleaner does not usually use the automatic winding apparatus, but winds and keeps the power cord on a winding part formed on the outside of the cleaner body.

However, to wind and keep the power cord on the outside of the cleaner body as described above, a user should directly grip the power cord with her or his hand and wind it on the winding part after a cleaning is completed. Since the power cord is often contaminated with dirt and dust while being moved onto a surface to be cleaned in cleaning, the user may soil her or his hand with dirt and dust if she or he grips the power cord with her or his hand and winds it on the winding part. In addition, if sharp foreign substances, such as bits of glass or the like, are adhered to the power cord, the user may cut her or his hand on the sharp foreign substances if she or he grips the power cord with her or his hand and winds it on the winding part.

Also, if the user quickly winds the power cord with her or his hand gripping the power cord, the user may get burnt in her or his hand due to a friction heat generated between the power cord and her or his hand.

### SUMMARY OF THE INVENTION

An aspect of the present disclosure is to solve at least the above problems and/or disadvantages and to provide at least the advantages described below. Accordingly, an aspect of the present disclosure is to provide a power cord winding apparatus for use in a vacuum cleaner capable of preventing a user's hands from being soiled or hurt and safely and sanitarily winding up a power cord and thus putting the power cord in order when the power cord is manually wound.

In order to achieve the above-described aspects of the present disclosure, there is provided a power cord winding apparatus for use in a vacuum cleaner including a loop unit formed to hang a power cord thereon, and a handle connected with the loop unit.

The loop unit may include a loop body formed in the form of a pipe and having an opening formed at one side thereof.

In addition, the loop unit may further include a door cover hinged to the opening of the loop body, and an elastic member to elastically support the door cover.

Also, the loop unit may include at least one roller disposed in the loop body.

At this time, preferably, but not necessarily, the at least one roller includes three rollers, one of which is disposed at an upper side of the loop body therein, and two of which are disposed at a lower side of the loop body therein.

Also, the handle may include a connecting part extended from the loop unit, and an arch part formed in the form of an arch above the connecting part.

The arch part may have a grip part formed corresponding to user's fingers thereon.

The connecting part may have a protecting cover vertically disposed on a side thereof.

According to another aspect of the present disclosure, there is provided a power cord winding apparatus for use in a vacuum cleaner including a loop body formed in the form of a pipe and having an opening formed on a side thereof, a door cover hinged to the opening of the loop body, three rollers rotatably disposed in the loop body to support a power cord passing through the inside of the loop body, a connecting part extended from an opposite side to the side of the loop body on which the opening is formed, and an arch part formed in the form of an arch above the connecting part.

Preferably, but not necessarily, the connecting part has a protecting part to prevent the power cord passing through the loop body from moving toward the arch part.

### BRIEF DESCRIPTION OF THE DRAWING FIGURES

The above aspect and other features of the present disclosure will become more apparent by describing in detail an exemplary embodiment thereof with reference to the attached drawing figures, wherein;

FIG. 1 is a perspective view exemplifying a power cord winding apparatus for use in a vacuum cleaner according to an exemplary embodiment of the present disclosure;

FIG. 2 is an exploded perspective view exemplifying the power cord winding apparatus of FIG. 1;

FIG. 3 is a perspective view exemplifying the power cord winding apparatus of FIG. 1 when a power cord is put into a loop body;

FIG. 4 is a perspective view exemplifying the power cord winding apparatus of FIG. 1 when the power cord is inserted into the loop body; and

FIG. 5 is a perspective view exemplifying an upright vacuum cleaner when a power cord is wound using the power cord winding apparatus of FIG. 1.

Throughout the drawings, the same reference numerals will be understood to refer to the same elements, features, and structures.

### DETAILED DESCRIPTION OF THE EXEMPLARY EMBODIMENTS

Hereinafter, a power cord winding apparatus for use in a vacuum cleaner according to an exemplary embodiment of the present disclosure will be described in detail with reference to the accompanying drawing figures.

The matters defined in the description such as a detailed arrangement and elements are nothing but the ones provided to assist in a comprehensive understanding of the disclosure. Thus, it is apparent that the present disclosure can be carried out without those defined matters. Also, well-known functions or arrangements are not described in detail since they would unnecessarily obscure the disclosure.

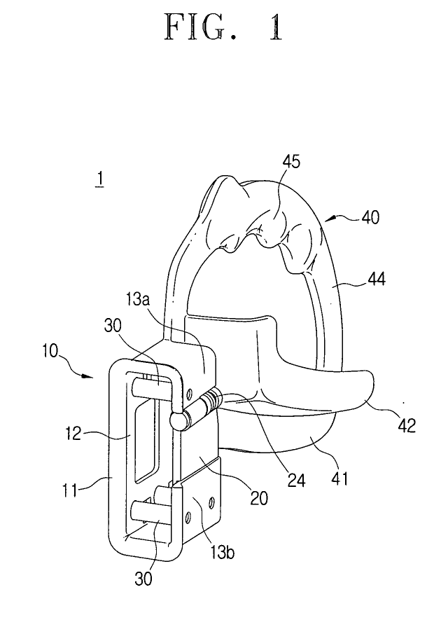

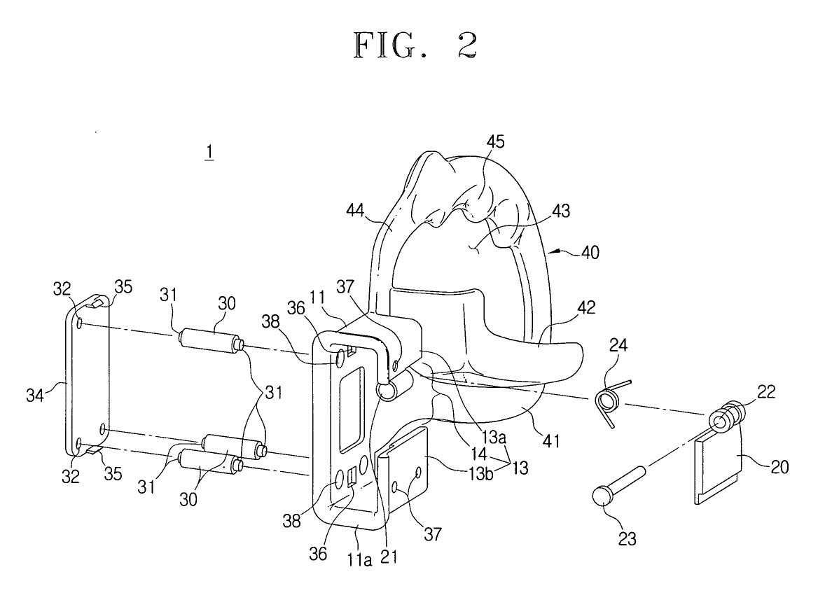

FIG. 1 is a perspective view exemplifying a power cord winding apparatus for use in a vacuum cleaner according to an exemplary embodiment of the present disclosure, and FIG. 2 is an exploded perspective view exemplifying the power cord winding apparatus of FIG. 1.

Referring to FIGS. 1 and 2, the power cord winding apparatus according to the exemplary embodiment of the present disclosure includes a loop unit 10 and a handle 40.

The loop unit 10 is formed to hang a power cord 3 (see FIG. 5) thereon, so that the user can wind the power cord 3 on the outside of a cleaner body 7 (see FIG. 5) by using the loop unit 10. Such a loop unit 10 includes a loop body 11, a door cover 20, and at least one roller 30.

The loop body 11 on which the power cord 3 is hung is formed in the form of an approximate rectangular pipe. The loop body 11 at one side 13 (referred as a right side below) thereof has an opening 14 formed, so that the power cord 3 can be put into the loop body 11 through the opening 14. Thus, the right side 13 of the loop body 11 is made up of an upper wall 13a, a lower wall 13b, and an opening 14 between the upper wall 13a and the lower wall 13b. It is preferable that a front end 11a and a rear end of the loop body 11 is formed in the form of an arch to prevent the power cord 3 passing through the inside of the loop body 10 from being damaged.

In the present embodiment, although the loop body 11 is illustrated and explained as formed in the form of the rectangular pipe, it can be also formed in any other shape if it can hang the power cord 3 thereon to wind on the cleaner body 7.

To prevent the power cord 3 inserted in the loop body 11 from escaping through the opening 14 in working, the door cover 20, which can selectively open or close the opening 14, is mounted to the right side 13 of the loop body 11. The door cover 20 is hinged on the right side 13 of the loop body 11, so that it can rotate in a certain angle to the right side 13 of the loop body 11. The hinge connection of the door cover 20 is achieved by a ring-shaped hinge hole 21, a door hinge hole 22 formed on the door cover 20, and a hinge axis 23. Accordingly, when the hinge axis 23 is inserted into the ring-shaped hinge hole 21 and the door hinge hole 22, the door cover 20 can rotate in a certain angle to the right side 13 of the loop body 11. The door cover 20 can also be mounted by various known hinge connection structures besides the hinge connection structure as described above.

It is preferable that a lower end of the door cover 20 is blocked and stopped by the lower wall 13b of the loop body 11, so that the door cover 20 is opened only in one direction to the right side 13 of the loop body 11. Here, preferably, but not necessarily, the door cover 20 is mounted, so that it is opened toward the inside of the loop body 11. In addition, an elastic member 24 can be disposed between the door cover 20 and the upper wall 13a of the loop body 11 to elastically urge the door cover 20 against the loop body 11. At this time, the elastic member 24 is formed to have an elastic force, which can push the door cover 20 toward the inside of the loop body 11 to open the opening 14 if a user pushes the door cover 20 and can return the door cover 20 to an original position to close the opening 14 if the user removes the pushing force to the door cover 20. Also, it is preferable that the elastic member 24 uses a torsion spring installed on the hinge axis 23 to elastically support the door cover 20.

The roller 30 is configured, so that at least one roller is disposed in the loop body 11, and prevents the power cord 3 from coming in direct contact with and rubbing against an inner surface of the loop body 11. The roller 30 can use a proper number of rollers according to a shape of the loop body 11. Referring to FIG. 1, in the present embodiment, three rollers 30 are rotatably disposed in the loop body 11. One roller 30 is disposed at an upper side of the loop body 11 therein, and two rollers 30 are disposed at a lower side of the loop body 11 therein. Accordingly, when the user rotates the power cord winding apparatus 1 to wind the power cord 3 after inserting the power cord 3 into the loop body 11, the power cord 3 is not in direct contact with the inner surface of the loop body 11, but is guided in rolling contact with at least one of the three rotating rollers 30. Thus, in this case, since a friction force is reduced more than that in a case in which the power cord 3 comes in direct contact with the inner surface of the loop body 11, winding the power cord 3 becomes very convenient.

Referring to FIG. 2, to rotatably dispose three rollers 30 in the loop body 11, three axis holes 37 are formed in the right side 13 of the loop body 11 to support the axes 31 of the rollers 30. That is, one axis hole 37 is formed in the upper wall 13a, and two axis holes 37 are formed in the lower wall 13b. To insert the rollers 30 into the loop body 11, three roller holes 38 through which the rollers 30 can pass are formed in another side 12 (referred as a left side below) opposite to the right side 13 of the loop body 10.

In addition, to rotatably support the three rollers 30 and prevent the assembled rollers 30 from escaping, a roller cover 34 is disposed on the left side 12 of the loop body 11. Three axis holes 32 are formed in the roller cover 34 to support the axes 31 of the rollers 30. Also, two hooks 35 are formed on an upper end and a lower end of the roller cover 34, respectively, and hook holes 36 into which the two hooks 35 are inserted, respectively, are formed in the left side 12 of the loop body 11. Accordingly, when the three rollers 30 are inserted into the loop body 11 through the roller holes 38 of the left side 12 of the loop body 11 thus to insert the roller axes 31 into the axis holes 37 of the right side 13 and then the hooks 35 of the roller cover 34 is inserted into the hook holes 36 of the loop body 11, the three rollers 30 are installed in the loop body 11. Then, the three rollers 30 can be rotated with the axes 31 at both ends thereof supported by the axis holes 37 of the right side of the loop body 11 and the axis holes 32 of the roller cover 34, respectively.

In case that the three rollers 30 are disassembled, when the hooks 35 of the roller cover 34 are pulled out of the hook holes 36 of the loop body 11, the roller cover 34 can be easily separated. After that, the three rollers 30 can be separated from the loop body 11 through the roller holes 38 of the loop body 11.

The handle 40 is connected with the loop body 11, and is formed in such a shape that it can be gripped by the user's hand. In the present embodiment, the handle 40 is made up of a connecting part 41 and an arch part 44.

The connecting part 41 is extended from the left side 12 of the loop body 11, so that the user can grip the connecting part 41 with her or his one hand. The arch part 44 is formed on an upper side of the connecting part 41. A grip part 45 is formed in a shape corresponding to the user's hand on an upper end of the arch part 44. Accordingly, when the user uses the power cord apparatus 1, she or he inserts her or his one hand into a space between the arch part 44 and the connecting part 41 to grip the grip part 45. On the other hand, since the grip part 45 is disposed higher than the loop body 11, the handle 40 does not interfere with the power cord 3 when the user winds the power cord 3. Accordingly, winding the power cord 3 becomes convenient.

Preferably, but not necessarily, a protecting cover 42 is disposed on one side of the connecting part 41, so that it vertically extends to one side of the connecting part 41 toward the right side 13 of the loop body 11. The protecting cover 42 prevents the power cord 3, which moves in the loop body 11, from touching user's hand, which grips the grip part 45 of the arch part 44. Accordingly, the protecting cover 42 is formed in a proper shape capable of protecting the user's hand, which grips the grip part 45.

In the present embodiment, although the handle 40 of the power cord winding apparatus 1 is illustrated as formed in form of a slightly distorted circle, it is not limited thereto, and can be also formed in various shapes.

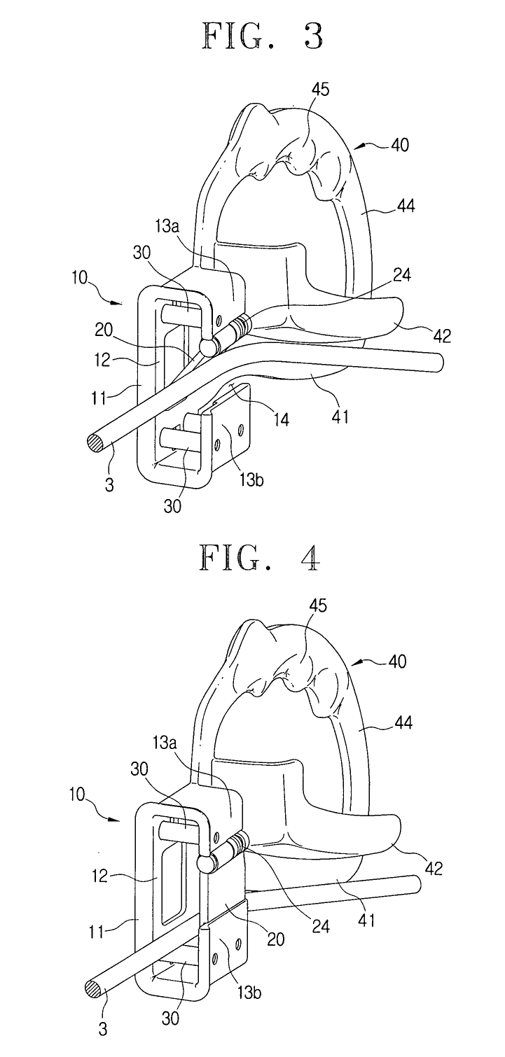

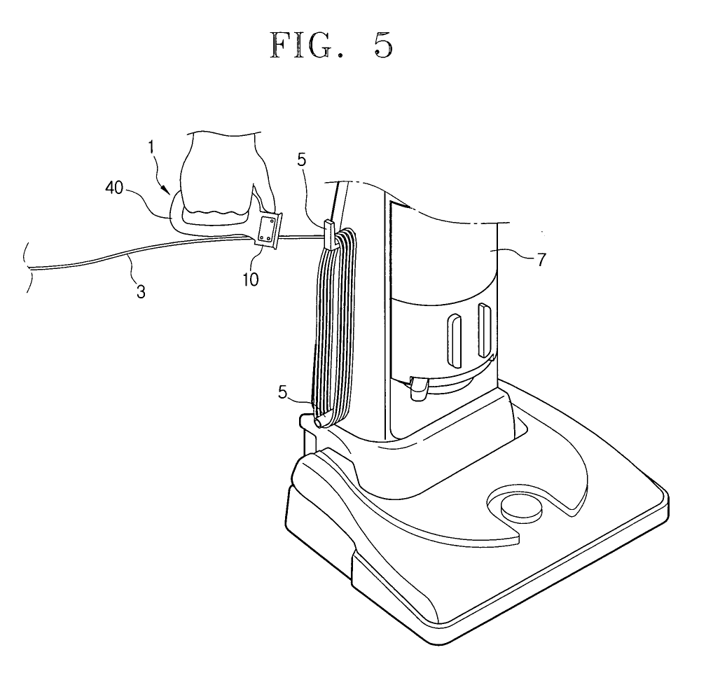

Hereinafter, an operation of the power cord winding apparatus 1 of the vacuum cleaner having the construction as described above will be described with reference to FIGS. 3 and 4.

First, to wind the power cord 3, the user contacts the power cord 3 with the door cover 20 and then pushes the power cord 3 toward the inside of the loop body 11, as illustrated in FIG. 3. As a result, the door cover 20 is pushed to open the opening 14, so that the power cord 3 can be put into the loop body 11.

When the user puts the power cord 3 in order so as not to interfere with the door cover 20 in the loop body 11, the door cover 20 is returned to an original position by an elastic force of the elastic member 24 to close the opening 14, and thus positioned in a state illustrated in FIG. 4. As a result, the power cord 3 inserted into the loop body 11 does not escape from the loop body 11.

After that, the user grips the handle 40 of the power cord winding apparatus 1 and then winds the power cord 3 on a winding part 5 formed on a side of the cleaner body 7 of the vacuum cleaner, as illustrated in FIG. 5. At this time, since the user can grip the grip part 45 while inserting her or his one hand between the connecting part 41 and the arch part 44 of the handle 40, it is convenient for the user to grip the handle 40 and to wind the power cord 3. Also, when the user winds the power cord 3 with the power cord winding apparatus 1, the power cord 3 passing through the loop unit 10 is guided by at least one of the three rollers 30 installed in the loop body 11, so that it smoothly passes through the loop body 11.

When the winding of the power cord 3 is completed, the user pushes the door cover 20 toward the inside of the loop body 11 to open the opening 14 and then pulls out the power cord 3 from the loop body 11.

As apparent from the foregoing description, according to the exemplary embodiment of the present disclosure, the power cord winding apparatus allows the user to wind the power cord on the outside of the vacuum cleaner without directly touching the power cord with her or his hand, thereby preventing the user's hand from soiling. Accordingly, the power cord winding apparatus according to the exemplary embodiment of the present disclosure is sanitary.

Further, if the power cord winding apparatus according to the exemplary embodiment of the present disclosure is used in winding the power cord, it can prevent user's hand from being hurt. Accordingly, the power cord winding apparatus according to the exemplary embodiment of the present disclosure is safe.

Also, if the power cord winding apparatus according to the exemplary embodiment of the present disclosure is used, the user can wind the power cord and thus put the power cord in order on the outside of the vacuum cleaner without directly touching the power cord with her or his hand, thereby allowing her or him to more conveniently, efficiently, and quickly wind the power cord.

While the exemplary embodiment of the present disclosure has been shown and described in order to exemplify the principle of the present disclosure, the present disclosure is not limited to the specific embodiment. It will be understood that various modifications and changes can be made by one skilled in the art without departing from the spirit and scope of the disclosure as defined by the appended claims. Therefore, it shall be considered that such modifications, changes and equivalents thereof are all included within the scope of the present disclosure.

What is claimed is:

1. A power cord winding apparatus for use in a vacuum cleaner, comprising:
a loop unit formed to hang a power cord thereon; and
a handle connected with the loop unit.

2. The apparatus of claim 1, wherein the loop unit comprises a loop body, the loop body comprising a pipe, and the loop body having an opening formed at one side of the loop body.

3. The apparatus of claim 2, wherein the loop unit further comprises a door cover hinged to the opening.

4. The apparatus of claim 1, wherein the loop unit further comprises an elastic member for elastically supporting the door cover.

5. The apparatus of claim 2, wherein the loop unit further comprises at least one roller disposed in the loop body.

6. The apparatus of claim 5, wherein the at least one roller comprises three rollers, a first one of the three rollers being disposed at an upper side of the loop body, a second and third one of the three rollers being disposed at a lower side of the loop body.

7. The apparatus of claim 1, wherein the handle comprises:
a connecting part extended from the loop unit; and
an arch part comprising an arch above the connecting part.

8. The apparatus of claim 7, wherein the arch part comprises a grip part formed corresponding to fingers of a user.

9. The apparatus of claim 7, wherein the connecting part comprises a protecting cover vertically disposed on a side of the connecting part.

10. A power cord winding apparatus for use in a vacuum cleaner, comprising:
a loop body comprising a pipe, the loop body comprising an opening formed on a first side of the loop body;
a door cover hinged to the opening;
three rollers rotatably disposed in the loop body to support a power cord passing through an inside of the loop body;
a connecting part extended from a second side of the loop body to a first side; and
an arch part comprising an arch above the connecting part.

11. The apparatus of claim 10, wherein the door cover is elastically supported by an elastic member.

12. The apparatus of claim 10, wherein the connecting part has a protecting part to prevent the power cord passing through the loop body from moving toward the arch part.
